(19) United States
(12) Patent Application Publication
(10) Pub. No.: US 2015/0369762 A1
(43) Pub. Date: Dec. 24, 2015

(54) QUANTITATIVE DETERMINATION OF NITROGEN SPECIES DISTRIBUTION IN DISPERSANTS

(71) Applicants: Frank Cheng-Yu WANG, Annandale, NJ (US); Simon Robert KELEMEN, Annandale, NJ (US); Liepao Oscar FARNG, Lawrenceville, NJ (US); Margaret May-Som WU, Skillman, NJ (US)

(72) Inventors: Frank Cheng-Yu WANG, Annandale, NJ (US); Simon Robert KELEMEN, Annandale, NJ (US); Liepao Oscar FARNG, Lawrenceville, NJ (US); Margaret May-Som WU, Skillman, NJ (US)

(73) Assignee: ExxonMobil Research and Engineering Company, Annandale, NJ (US)

(21) Appl. No.: 14/728,311

(22) Filed: Jun. 2, 2015

Related U.S. Application Data
(60) Provisional application No. 62/013,751, filed on Jun. 18, 2014.

(51) Int. Cl. G01N 23/227

(52) U.S. Cl. CPC G01N 23/2273

(57) ABSTRACT

The nitrogen species in a long chain alkenyl succinimide are quantitated and speciated by means of X-Ray Photoelectron Spectroscopy with speciation being made by chemometrically curve resolving the XPS spectrum.

### CROSS-REFERENCE TO RELATED APPLICATIONS

This application claims priority to U.S. Provisional Application Ser. No. 62/013,751 filed Jun. 18, 2014, herein incorporated by reference in its entirety.

### FIELD OF THE INVENTION

This invention relates to a method for the quantitative determination of nitrogen species in dispersants and more particularly to the quantitative determination of nitrogen species relative to carbon and their distribution by chemical class in dispersants derived from succinic anhydride and polyamines.

### BACKGROUND OF THE INVENTION

The succinimides are ashless, polymeric chemicals widely used as dispersants in a variety of organic fluids, especially those based on petroleum oils, including crude oils, petroleum refinery streams and products such as engine oils to keep sludge, soot, oxidation products, and other particulate deposit precursors dispersed in the oil so that these by-products of heat and combustion do not form fouling deposits either during processing or when in use in engines, They also find use in greases and other fluids and semi-fluids such as inks. Dispersants for different types of applications may be called different anmes. For example, for fuels, they could be called detergents and for lubricants, they are usually called dispersants or ashless dispersants. Finally for crude oils, they may be called anti-foulant additives. Dispersants of this type are widely available from commercial suppliers such as Lubrizol, Afton, Infineum, BASF and Chevron Oronite.

The succinimides are normally made by first reacting a long chain polymeric alkene based on C₂-C₈ olefin and typically having a number average molecular weight of from about 200 to about 30,000 with an unsaturated aliphatic dicarboxylic acid anhydride. The most common starting materials are polyisobutylene and maleic anhydride. The resulting long chain alkenyl-substituted maleic anhydride is then reacted with a polyamine such as tetraethylene pentamine to form the final succinimide product. The long chain alkenyl group provides a hydrocarbon tail for solubility in a lube oil, crude, or refinery stream; the succinate component links the hydrocarbon tail to the polar head provided by the polyamine portion of the molecule that is believed to attach to the particulate surface. The molecular weight of the final succinimide product is typically 500 to 10,000 Daltons, but more commonly from 1,000 to 3,000 Daltons. The succinimide may be borated by reaction with a borating agent such as boric acid, an ortho-borate, or a meta-borate, for example, trimethyl metaborate (trimethoxyboroxine), triethyl metaborate, tributyl metaborate, trimethyl borate, triethylborate, triisopropyl borate (triisopropoxyborane), tributyl borate (tributoxyborane) or tri-t-butyl borate.

There are numerous patents describing the succinimides and their synthesis; it suffices in view of their widespread production and use to cite only a few exemplary disclosures including, for example. U.S. Pat. No. 4,388,201; U.S. Pat. No. 4,686,054; U.S. Pat. No. 5,211,834; U.S. Pat. No. 6,770,605; U.S. Pat. No. 6,858,070; U.S. Pat. No. 7,329,635.

Commercial dispersants are typically depicted with the idealized bis-imide structure shown below, although mono-imide forms are common as well.

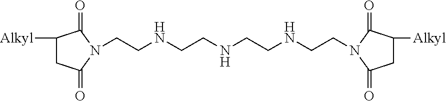

The structures of these dispersants are actually quite complex since the presence of multiple isomers in the polyamine precursor will result in a mixture of products, as shown below:

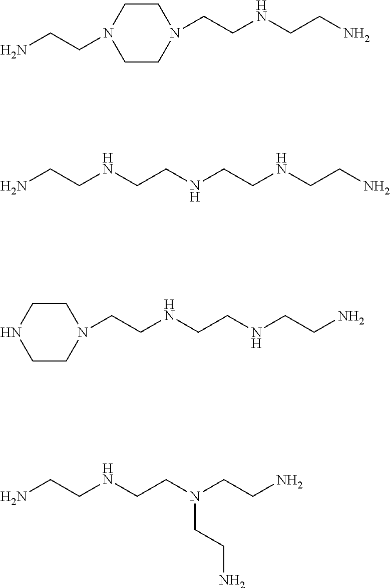 [SMILES: NCCNCCN1CCN(CCN)CC1 ; NCCNCCNCCNCCN ; NCCNCCNCCN1CCNCC1 ; NCCNCCN(CCN)CCN]

Also, incomplete reaction with the succinic anhydride will result in a complex mixture of mono-, bis-, and tri-imides. Representative structures that are present in this mixture include the following where SA=succinic anhydride and PAM=polyamine:

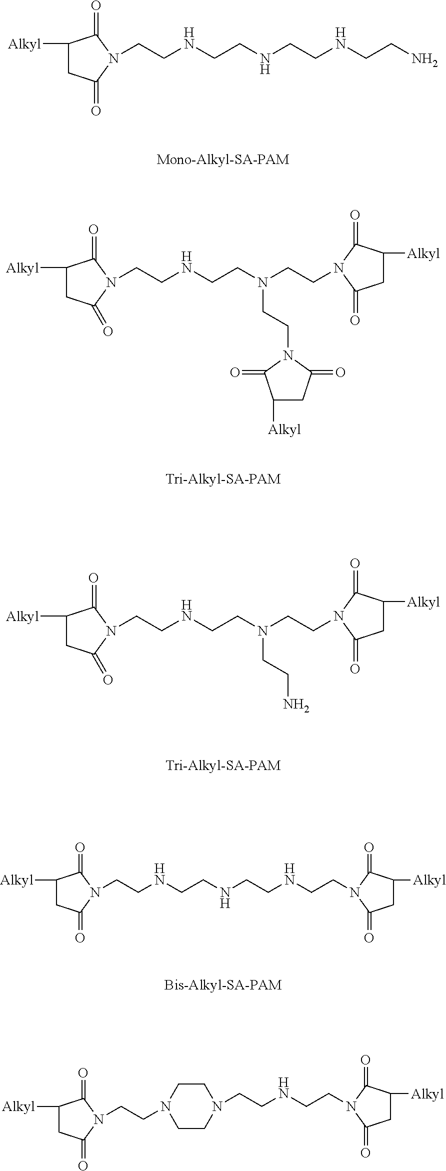

The dispersant properties of these materials are related to the amount of available polar groups (i.e. basic nitrogen) which, in turn, will be a function of the distribution of the various nitrogen species. Information about the various nitrogen species present and their distribution is therefore significant for to the performance of the products and, accordingly, it is desirable to have a fast and economic method of obtaining this information.

Current methods for determining nitrogen species in dispersants are (1) elemental analysis: this method only gives the wt % N and no information on chemical class, e.g. amine, amide, imide and (2) Infrared (IR) spectroscopy: differentiates amides from imides but cannot speciate amine types.

### SUMMARY OF THE INVENTION

We have now found that the X-ray Photoelectron Spectroscopy (XPS) method has the advantage over existing techniques for the quantitation and speciation of nitrogen-containing succinimides in that it is capable of determining the total number of nitrogen species relative to carbon and their distribution in terms of amine, amide/imide, quaternary nitrogen (protonated basic nitrogen). The method requires a small amount of sample (mg) and short data acquisition time relative to 15N NMR.

According to the present invention, therefore, the distribution of nitrogen species in a long chain alkenyl succinimide is quantitatively determined by means of X-Ray Photoelectron Spectroscopy.

### DRAWINGS

In the accompanying drawings. FIGS. 1 to 3 are the XPS spectra for representative succinimide dispersants.

### DETAILED DESCRIPTION

X-ray Photoelectron Spectroscopy (XPS) is a surface-sensitive quantitative spectroscopic technique that measures the elemental composition at the parts per thousand range, empirical formula, chemical state and electronic state of the elements that exist within a material. XPS spectra are obtained by irradiating a material with a beam of X-rays while simultaneously measuring the kinetic energy and number of electrons that escape from the top of the material being analyzed, (˜90% of the signal from the first 5 nm) and is sensitive to all elements except hydrogen.

Commercial XPS instruments typically use aluminum Kα X-rays or magnesium Kα X-rays. The energy of the aluminum Kα X-rays, Ephoton=1486.7 eV and because the emitted electrons' kinetic energies are measured, the electron binding energy of each of the emitted electrons can be determined by using the equation:

E_{binding}=Eₚₕₒₜₒₙ−(E_{kinetic}+work function)

where E_{binding} is the binding energy (BE) of the electron, Eₚₕₒₜₒₙ is the energy of the X-ray photons being used, E_{kinetic} is the kinetic energy of the electron as measured by the instrument. The work function term is an adjustable energy correction that accounts for the few eV of kinetic energy given up by the photoelectron as it becomes absorbed by the instrument's detector. For the purposes of the quantitation and speciation of the succinimides, an energy correction to account for sample charging based on the carbon (1 s) peak at 284,8 eV is appropriate.

In XPS analysis, different chemical forms of the same element will appear at slightly different chemical shifts indicating different binding energies. A sample containing a mixture of chemical forms will appear broader than a sample containing a single chemical environment, in order to obtain quantitative data on the chemical forms of nitrogen in is necessary to apply the chemometric technique of curve resolution on the XPS nitrogen (1 s) spectrum. The nitrogen (1 s) additive spectra are curve-resolved using three peaks at fixed energy positions of 399.0, 400.2, and 401.3 (±0.1) eV and full width half maximum (FWHM)=1.4 (±0.1) eV. These peaks correspond to the energy positions expected for amine (primary/secondary/tertiary), amide/imide, and quaternary nitrogen forms respectively,

As the succinimides may be semi-solid or, alternatively, available as oil suspensions, the XPS sample may be prepared by smearing the sample onto a suitable support such as a copper plate or nub.

The XPS spectrum can be used to determine the nitrogen species of succinimide compositions for use as dispersants, detergents, anti-foulant additives or, in addition, to serve as tools to differentiate counterfeit additive products used in lubricants, fuels, crude oils, and other petroleum products.

### EXAMPLES

Samples of alkenyl succinimide (alkyl-SA-PAM) additives were smeared onto a copper nub for XPS analysis by a Kratos™ Axis Ultra system using monochromatic Al Kα radiation. The unit was equipped with automatic sample charge neutralization to ensure a uniform sample space charge. An energy correction was made to account for sample charging based on the carbon (1 s) peak at 284.8 eV. The elemental concentrations are reported relative to carbon, calculated from XPS spectra based on the area of the characteristic photoelectron peaks after correcting for atomic sensitivity.

FIG. 1 is a representative XPS spectrum of an alkenyl-SA-PAM (alkenyl succinimide) dispersant. This particular spectrum shows two peaks corresponding to (1) amine: the total of primary, secondary, and tertiary amines (—C—NH_{?;} —(C—)₂NH, and —(C—)₃N), (2) (O═C)x-N: the total of imide and/or amide. The total nitrogen per 100 carbon atoms can also be determined.

The ratio of (O═C)x-N to amine can be used as an indicator of the distribution of mono-Alkyl-SA-PAM, bis-Alkyl-SA-PAM and tri-Alkyl-SA-PAM. If imides linkage is the only linkage formed in the Alkyl-SA-PAM, the distribution of mono-Alkyl-SA-PAM, bis-Alkyl-SA-PAM and tri-Alkyl-SA-PAM can be explored/calculated. The distribution of mono-Alkyl-SA-PAM, to bis-Alkyl-SA-PAM to tri-Alkyl-SA-PAM can then be further correlated to the performance of fouling prevention in a laboratory testing unit.

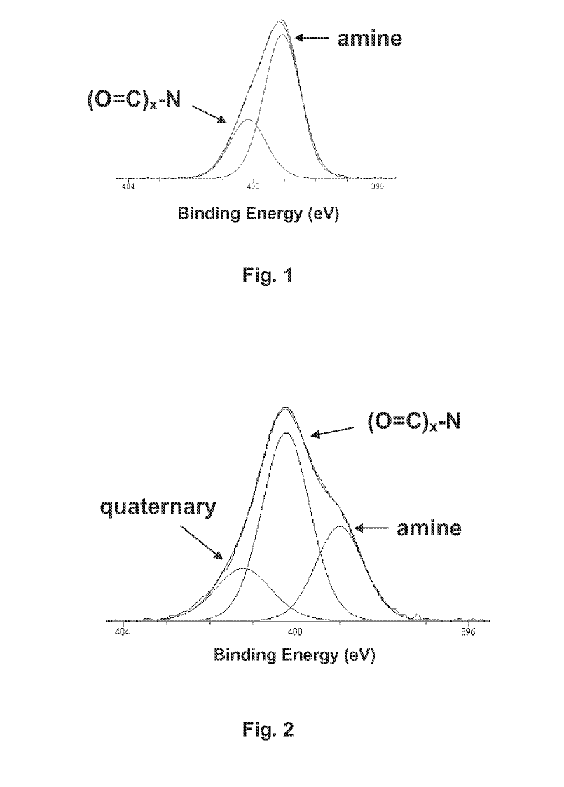

FIG. 2 is a representative XPS spectrum of a borated alkyl-SA-PAM dispersant prepared by the boration of the dispersant of FIG. 1. The quaternary nitrogen is a result of the protonation of the basic nitrogen from boric acid and can be distinguished from amide/imide and amide forms of nitrogen.

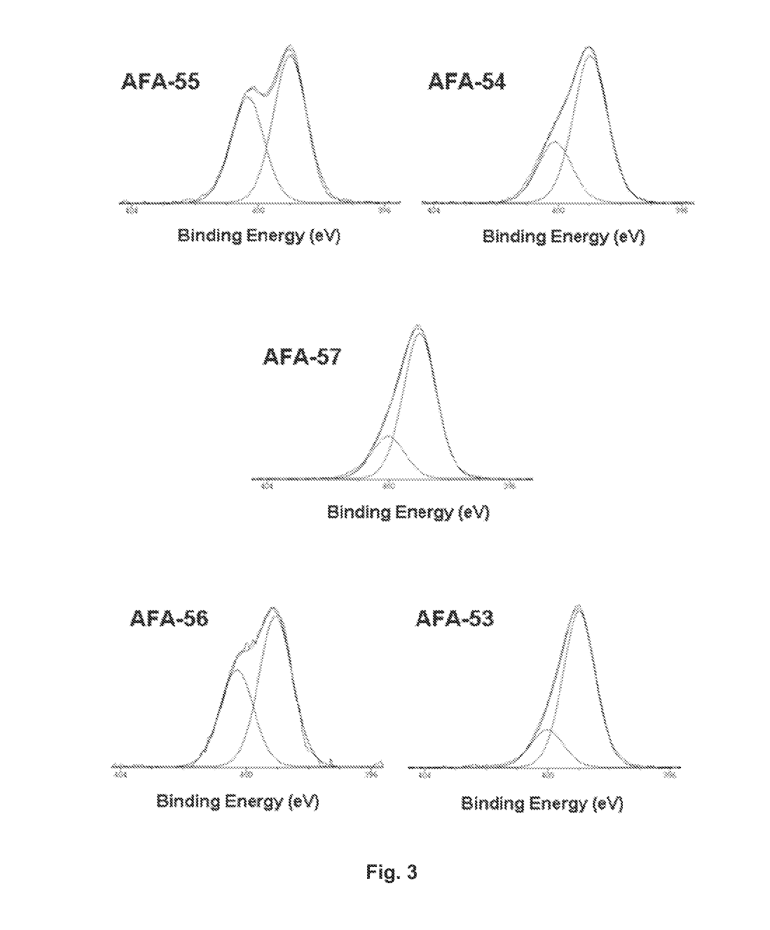

FIG. 3 illustrates several examples of typical XPS spectra for a representative set of dispersants. The total number of nitrogen species relative to carbon and their distribution in terms of amine and amide/inside is shown in Table 1. Each row of the table corresponds to a separate Alkyl-SA-PAM sample.

TABLE 1

| | |
|---|---|
| Per 100 C | Mole Percent |

| Succinimide | Total N | Amine | (N—Cx)═O |
|---|---|---|---|
| AFA-56 | 0.9 | 60 | 40 |
| AFA-53 | 4.4 | 80 | 20 |
| AFA-57 | 6.2 | 78 | 22 |
| AFA-55 | 3.4 | 58 | 42 |
| AFA-54 | 3.5 | 71 | 29 |

By combining the performance data in the laboratory fouling test unit with the structural data determined by the XPS method, the correlation between the structure and performance can be quickly elucidated. Based on the correlation, the preferred the structure criteria can be defined. A performance scale that is based on this XPS nitrogen bonding environment measurement can be established. This scale can be used for (1) predicting an Alkyl-SA-PAM performance based on the structure, (2) guiding synthesis reaction conditions, (3) guiding necessary synthesis mechanism and (4) guiding the required ratio of various reactants to guarantee the successful synthesis of the Alkyl-SA-PAM with the required total nitrogen content and the preferred (O═C)x-N to amine concentration ratio.

1. A method of quantitating and speciating the nitrogen compounds in a succinimide which comprises subjecting the succinimide to X-Ray Photoelectron Spectroscopy (XPS) to produce an XPS spectrum of the electron binding energies of the succinimide.

2. A method according to claim 1 in which the electron binding energies of the succinimide are in the range from about 380 eV to 410 eV.

3. A method according to claim 1 in which the electron binding energies of the succinimide are in the range from about 390 eV to 405 eV.

4. A method according to claim 1 which includes the step of chemometrically curve resolving the XPS spectrum.

5. A method according to claim 4 in which the XPS spectrum is chemometrically curve resolved to indicate peaks corresponding to total amine and total imide and/or amide.

6. A method according to claim 4 in which the XPS spectrum is chemometrically curve resolved to indicate peaks corresponding to total primary, secondary, and tertiary amines (—C—NH₂, —(C—)₂NH, and —(C—)₃N).

7. A method according to claim 4 in which the XPS spectrum is chemometrically curve resolved to indicate peaks at fixed energy positions of 399.0, 400.2, and 401.3 (±0.1) eV.

8. A method according to claim 1 in which the XPS spectrum is produced using aluminum Kα X-rays.

9. A method according to claim 1 in which the succinimide is a bis-imide.

10. A method according to claim 1 in which the succinimide is a borated succinimide.
